(19) United States
(12) Patent Application Publication
(10) Pub. No.: US 2009/0194033 A1
(43) Pub. Date: Aug. 6, 2009

(54) Netliner Litter Box Cleaning System

(76) Inventor: Delbert J. Modlin, Folsom, CA (US)

Correspondence Address: DONALD W. MEEKER, 924 EAST OCEAN FRONT, # E, NEWPORT BEACH, CA, 92661, US

(21) Appl. No.: 12/027,051

(22) Filed: Feb. 6, 2008

(51) Int. Cl. A01K 29/00

(52) U.S. Cl. 119/167; 119/170

(57) ABSTRACT

An array of disposable mesh liner bags are removably attached to a rigid flat insert that is held in place with retainers in the bottom of a pet litter box. Each bag has a center mesh and peripheral draw string to lift each bag individually. Litter is sifted through the mesh and solid waste lifted out and tied up in the bag for disposal. A solid mesh bag at the bottom of the array lifts out all of the litter after the top bags have all been used. A removable lid with a peripheral rim holds down the bags overlapping a top ridge of the box walls. A center lid opening admits pets to use the litter box.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to litter boxes used for the collection of animal waste and particularly to a litter box system for use with clumping litter which comprises a plurality of disposable mesh liner bags having a plurality of holes forming a mesh in their bottom removably attached to a rigid flat insert and a draw string at their top, a plurality of retainers to hold the insert at the bottom of the litter box so that the top mesh liner bag can be detached from the rigid flat insert and lifted out of the pet litter box allowing unsoiled litter to pass through while collecting and removing unwanted solid pet waste for disposal.

2. Description of Related Art Including Information Disclosed Under 37 CFR 1.97 and 1.98

It is customary to use litter boxes for receiving animal waste in a quantity of litter. To ensure cleanliness and to reduce odors, the animal waste must be removed from the litter on a frequent basis. This usually requires a pet owner to manually scoop the animal waste from the litter. This continual litter box maintenance is unpleasant and inconvenient for the pet owner. Although automatic litter boxes are available for use they are very expensive, jam often and are difficult to maintain. The prior art does not adequately solve the problem.

U.S. Pat. No. 4,312,295, issued Jan. 26, 1982 to Harrington, claims a cat box litter screening device. A liner is provided for use in a litter box or tray for cats, which is of conventional design having sides and a bottom, the liner having a plurality of flexible sieve sheets overlying a flexible impervious sheet, sheets being removably attached to an underlying semi-rigid support, and being of such size as to overlap the sides of the litter box, the support having an attachment device for attaching the support to the bottom of the litter box, such that when litter is placed in the box over the liner packet, the sieve sheets are periodically removed to take out fecal matter by screening and aerating the litter, and lastly the impervious sheet is removed to remove and discard the litter before replacement with a new liner packet and new litter whereby the period over which litter is usable is substantially extended.

U.S. Pat. No. 5,158,042, issued Oct. 27, 1992 to Hammerslag, shows a kitty litter disposal device for hygienically reusing kitty litter in a litter box, which has a plurality of fine-meshed nets in juxtaposition with the bottom of the litter box in the box. Each net covers the bottom of the litter box and extends along the inside surfaces of the sides of the litter box, over the lip of the litter box and along at least part of the outside surfaces of the sides. Net fasteners in the nets and on selected sides of the litter box releasably fasten the nets in position in the box, whereby kitty litter in the litter box on the nets is siftable via the uppermost of the nets upon unfastening of the uppermost of the nets and manual holding of same in the box at a distance above the remaining ones of the nets thereby to pass the kitty litter into the box.

U.S. Pat. No. 5,207,772, issued May 4, 1993 to Lauretta, indicates a litter box liner system and method for use with an animal waste litter box and litter material which has separably attached layers of perforated filters which line the bottom of the box over which litter material is spread. Periodic removal of each filter recirculates the litter material from the bottom up and catches solid waste for convenient and sanitary disposal. A non-perforated bottom layer lines and protects the interior of the litter box from contact with the litter material and captures all of the litter material for convenient and sanitary disposal. The separably attached layers of perforated filters may be individual sheets or incorporated into individual interfitting filter liner bags which fit over the litter box and contain solid waste upon removal. Alternatively, the top facing surface of a single liner bag may include layers of separably attached filters.

U.S. Pat. No. 5,062,392, issued Nov. 5, 1991 to Lavash, puts forth a combined litter filtering and disposal system for pet litter. The system comprises a highly porous litter filtering member underlying a protective member which prevents the pet from coming in contact with and damaging the filtering member in use. The protective member includes a centrally located slit, for allowing granular material, such as litter, to readily pass through onto the underlying filtering member when the system is lifted from the litter box. By employing two discrete members oriented as described, the functions of filtering and resistance to cat's claws are decoupled from one another, i.e., there is no longer a need to compromise between strength and filtering efficiency. Each member of the bi-component system can be optimally designed for its intended function, i.e., the uppermost protective member which underlies the litter is designed to provide reliable resistance to ripping by or entanglement of the cat's claws, while the lowermost highly porous filtering member is designed to maximize filtering efficiency by providing more rapid separation of fecal excrement from the litter when the system is lifted from the litter pan.

U.S. Pat. No. 6,595,159, issued Jul. 22, 2003 to Montalbano, puts forth a bag sifting system, for use with a cat litter box in separating waste products and clumped litter from uncontaminated litter, using a plurality of bags which are extended over the litter box before the litter box is filled with litter. As the litter becomes partially soiled, an uppermost of the bags is lifted from the litter box. Each bag has a sifting region having a plurality of sifting holes which allow uncontaminated litter to fall onto the remaining bags in the litter box below. The waste products and clumped litter, being too large to fall through the sifting holes, remains in the bag. The bag has a non-sifting region without holes, such that the bag is then tilted and rotated so that the waste products and clumped litter fall into the non-sifting region, and are contained therein for disposal.

U.S. Pat. No. 5,983,832, issued Nov. 16, 1999 to Seo, discloses a cat litter box with bag system comprising a pan. A litter disposal bag is nested into the pan. A plurality of feces disposal bags are nested into the pan over the litter disposal bag. A protective insert having an open bottom is nested into the pan over the uppermost feces disposal bag. When a quantity of litter is placed into the pan and used by a cat to deposit feces, the protective insert can be withdrawn and each feces disposal bag can be removed one at a time as needed to separate the feces from the litter, then tied and discarded. When the litter disposal bag is reached and withdrawn it will take all of the litter out of the pan to be discarded.

Two U.S. Pat. No. 5,890,452 issued Apr. 6, 1999 and U.S. Pat. No. 5,752,466 issued May 19, 1998 to Lundeen, indicate a flexible, reusable quick sifter for use with a litter box which employs litter of the clumping type. The sifter has an expandable or stretchable netting secured to a hydrophobic surface across an opening such as a slit in a central area of the box. On lifting, clumping litter disposed in the central area spreads the netting and the slit open to allow unclumped litter to sift through the netting. The clumped litter is retained in the quick sifter and netting material for convenient disposal. The quick sifter is made from a rubberized fabric for reusability.

U.S. Pat. No. 4,308,825, issued Jan. 5, 1982 to Stepanian, concerns a device for removing pet odors and holding pet waste materials comprising a receptacle, absorbent porous material placed into the receptacle, screen material placed onto the absorbent porous material and secured onto the receptacle, and a deodorizing, absorbent, granular material placed onto the screen material.

U.S. Pat. No. 4,872,420, issued Oct. 10, 1989 to Shepard, claims a disposable cat litter box comprising a liner pan for receiving cat litter, with the liner pan having an open top, bottom and sides and cat litter disposed in the liner pan. A disposal bag having an opening at least equal to the bottom of the liner pan and a drawstring around the opening is attached to the bottom of the exterior of the liner pan with the opening of the disposal bag around the sides of the liner pan. A covering lid is secured to the top of the liner pan to hold the cat litter inside the liner pan with a tear cord for removing the lid from the liner pan to expose the cat litter during use. After use, pulling on the drawstring causes the opening of the bag to cover the open top and fully enclose the liner pan and any used cat litter therein.

U.S. Pat. No. 5,551,376, issued Sep. 3, 1996 to Lundeen, discloses a liner-sieve system for use with a litter box which employs litter of the clumping type. The system includes a cassette having a plurality of flexible liner sheets stacked over the litter box with netting secured to an upper surface of each liner sheet disposed in a central area of the box. A releasable flap is formed in each liner sheet beneath the netting. The liner sheets are fused together at peripheral edges which can be draped over the wall of the litter box, and the liner sheets are perforated adjacent the peripheral edges for separation of an uppermost liner sheet from the next lower liner sheet. Clumping litter disposed in the central area opens the flap to allow the unclumped litter to sift through the netting onto the next lower liner sheet. The clumped litter and feces is retained in the liner and netting material for convenient disposal. The flap generally inhibits litter from passing through the netting until the uppermost liner sheet is lifted from the next lower liner sheet.

U.S. Pat. No. 5,121,712, issued Jun. 16, 1992 to Schulein, Jr., describes an animal litter box liner of flexible, sheet-like material which is provided with holes of an appropriate size and location for allowing clean, dry litter to sift therethrough while simultaneously retaining clumps of urine-soiled litter and feces within the liner as it is lifted from a litter pan.

U.S. Pat. No. 3,809,013, issued May 7, 1974 to Rigney, is for a disposable insert for placement in an open, self-supporting tray for use as an animal litter box. A number of disposable screens are stacked on top of each other, constructed of flat, thin flexible material such as paper or plastic film, include a plurality of holes at their center portion and are placed in the tray so that walls of the tray fold the screens into a receptacle. Means is provided for closing the holes in the screens to prevent articles from entering the holes and for opening them upon lifting a screen from the stack. To change the liner and dispose of waste, the top liner is lifted whereby litter sifts through the holes onto the remaining screens for reuse while the liner and the waste thereon are discarded.

U.S. Pat. No. 6,668,755, issued Dec. 30, 2003 to Koster, provides a device for carrying objects, in particular excrement from a cat litter box. This device consists of a film sheet which is provided with openings and is placed on the base of a cat litter tray. The cat litter tray is then filled with grit in the conventional manner. To remove excrement the user has to grasp the film at handles in the film sheet which extend outside the cat litter tray close to the ends. The openings are made such that excrement cannot pass through openings but the cat litter grit will remain on the base of the cat litter tray. Optionally a number of such film sheets can be placed on top of one another for regular removal of excrement without a large quantity of grit being consumed.

U.S. Pat. No. 4,615,300, issued Oct. 7, 1986 to McDonough, describes a litter box liner which includes a plurality of removable layers stacked one inside of the other and conformable to the shape of the interior surface of a litter box. The liner includes an imperforate bottom layer and a plurality of screening layers positioned above the bottom layer. Each screening layer includes a bottom wall with a plurality of openings therethrough which are large enough to pass granular litter but small enough to block animal excrement. The screening layer also includes an imperforate flap attached beneath the bottom wall by a flexible edge connector, with the flap being large enough to cover all of the openings. The animal excrement may be screened from the litter by pulling upward on the uppermost layer and allowing the litter to pass through the openings as the flap drops down.

U.S. Pat. No. 4,723,510, issued Feb. 9, 1988 to Skillestad, discloses a disposable litter collection device for facilitating the removal of feline feces from a litter box, upon which is placed kitty litter. The device comprises a plurality of semi-rigid sheets or films, all but one of which has a series of perforations therein. The perforations are sized to permit the sifting of kitty litter, but are adapted to not pass the feces therethrough. The feces are removed merely by lifting the film from the litter box.

U.S. Pat. No. 4,870,924, issued Oct. 3, 1989 to Wolfe, is for a disposable cat litter box system including a tray which may have inwardly canted edges and a waterproof bottom. Inserted in the tray is at least one orificed filter sheet, and preferably several, having some type of corner or edge lifting means. Also desirably provided is a filter protector comprising a mat having upward extending protrusions disposed in register with the filter sheet orifices to pass through the latter and protect the filter sheets from damage by the clawing of the cat through litter material which is deposited in the tray over the filter sheets and the filter protector, where the latter is also used. Deodorizing strips, capsules and/or filter protector tips may also be provided.

U.S. Pat. No. 5,038,721, issued Aug. 13, 1991 to Ouellette, concerns an animal waste collection system comprising nonsorbent, nonclumping litter, liquid sorbent means and a filter. The system separates the pet excreta collection, storage and disposal functions wherein each individual component used to perform each of these functions is optimized for its intended purpose. The invention permits almost indefinite recycling of the substantially nonsorbent, nonclumping granular litter material used by the animal to bury its solid excreta. The combination of the invention includes a porous filtering member exhibiting a pore size which will readily permit the granular litter material to pass therethrough, yet retain substantially all of the solid animal excreta coming in contact with the filtering member during the filtering operation. A protective member capable of substantially resisting damage when subjected to digging or clawing by animals is secured in superposed relation to and completely overlies the uppermost surface of the porous filtering member. The protective member includes means for forming an opening having a predetermined periphery in its uppermost surface when the protective member is lifted from the litter box to initiate the filtering operation. The filtering member is secured in underlying relation about the predetermined periphery of the opening formed in the protective member so that the filtering member is protected from damage due to digging or clawing by animals during the normal use cycle, yet substantially all of the nonsorbent, nonclumping granular litter material containing the solid animal excreta will pass through the opening and be filtered by the filtering member when the protective member is lifted from the litter box.

U.S. Pat. No. 5,031,578, issued Jul. 16, 1991 to Hammons, is for an animal litter box system which reduces odor and extends the useful life of litter by delivering and concentrating urine in an area specifically designed to prevent odor formation. The system permits almost indefinite recycling of the substantially nonsorbent, nonclumping granular litter material used by the animal to bury its solid excreta. The combination further includes a porous filtering member exhibiting a pore size which will readily permit the granular litter material to pass therethrough, yet retain substantially all of the solid animal excreta coming in contact with the filtering member during the filtering operation. A protective member capable of substantially resisting damage when subjected to digging or clawing by animals is secured in superposed relation to and completely overlies the uppermost surface of the porous filtering member. The protective member includes means for forming an opening having a predetermined periphery in its uppermost surface when the protective member is lifted from the litter box to initiate the filtering operation. The filtering member is secured in underlying relation about the predetermined periphery of the opening formed in the protective member so that the filtering member is protected from damage due to digging or clawing by animals during the normal use cycle, yet substantially all of the nonsorbent, nonclumping granular litter material containing the solid animal excreta will pass through the opening and be filtered by the filtering member when the protective member is lifted from the litter box. The protective member further includes liquid sorbent means including an odor abatement agent to prevent or reduce the development of odor in the absorbed liquid. The liquid sorbent means absorbs liquid animal excreta so that the liquid animal excreta contained in the sorbent means can be removed from the litter box and disposed of along with the solid animal excreta retained on the filtering member when the filtering operation has been completed.

U.S. Pat. No. 5,564,366, issued Oct. 15, 1996 to Hancock, claims a litter box system and method for containing and separating animal waste from litter includes a first box and a second box forming a container which houses the litter, a floor card, and a cover sheet for absorbing odors. The litter box system also includes an additional floor card for use during the cleaning process, which includes installation of the additional floor card, a clean cover sheet, and a filter bag. The litter box system is inverted, depositing the litter into the filter bag for filtering litter through apertures in the filter bag, while retaining animal waste within the filter bag for disposal. Each of the boxes is substantially identical having an opening for passage of animal waste into the litter box system. A flange surrounds the opening for helping to retain the litter within the litter box system during use by an animal. The cover sheet may be coated with a protective material, such as wax, for substantially preventing the passage of liquid animal waste therethrough. Handles attached to the first and second boxes, floor cards, and filter bag enable a person to grasp the handles for manipulation of the boxes, floor cards, and filter bag. An alternative embodiment of the litter box system, which utilizes a plurality of cover sheets or a plurality of cover sheets and filter bags positioned alternately together within one of the boxes, does not need to be inverted to remove the soiled cover sheets.

U.S. Patent Application #20060236949, published Oct. 26, 2006 by Hill, illustrates a pet waste receptacle including an outer frame and an inner compartment. Positioned within the frame are one or more removable trays having a liquid permeable base. The trays rest atop the inner compartment, and retain a pet attractable cover layer material that allows liquid waste to flow through the liquid permeable base and into the inner compartment. The inner compartment, or a box placed within the compartment, contains a liquid waste absorbing material. The trays may include one or more handles for removing the trays. Further, a support structure and cover may be attached to the outer frame to protect the receptacle from adverse weather. Side and end panels may also be attached to the support structure to partially enclose the receptacle.

U.S. Pat. No. D378,451, issued Mar. 11, 1997 to Schmidt, illustrates the ornamental design for a combined screen liner and litter pan.

U.S. Pat. No. 4,646,684, issued Mar. 3, 1987 to Embry, shows an animal waste container for receiving a liner and a granular material to be placed on the liner for absorbing and covering animal wastes includes a rectangular enclosure having erect sidewalls and a bottom wall. A gap is provided at each corner of the enclosure between adjacent sidewalls of the enclosure. A sufficiently large, flat rectangular liner placed in the enclosure overlaying the bottom wall will fold into the gaps and an edge portion of the liner will assume an erect orientation overlying the sidewalls. The liner system comprises a flat base impermeable liner and a plurality of flat foraminous liners placed directly on base liner so as to overlay it. Each foraminous liner includes a plurality of openings, for sifting fecal matter from cat litter

U.S. Pat. No. 5,129,364, issued Jul. 14, 1992 to Pirkle, provides a disposable cat litter box which is made entirely of a single piece of cardboard. The litter box has a lower portion to hold cat litter and an expandable upper portion which completely encloses the cat litter except for providing an opening for ingress and egress of the cat. A removable mesh-type litter bag is provided which can be simply removed and thrown away when the litter box is full to renew the same for additional use. A charcoal filter can be provided to control odors.

U.S. Pat. No. 5,709,171, issued Jan. 20, 1998 to Moore, III, describes a disposable cat litter box that includes a supporting base and a removable, disposable bag of litter which is designed to fit inside of the base. The disposable bag is provided with a draw string to facilitate its closure after use, and a cardboard bottom inside of the bag provides for a conforming fit of the bag within the base. In a modified embodiment, a plurality of disposable bags are nested inside of the base, and each bag is of a pleated structure with small reinforcement wires going in vertical and horizontal directions. This allows one side of the bag to be lifted upwardly within the base so as to form a deflecting shield which reduces the amount of litter spillage from the bag during a use of the box by a cat.

U.S. Pat. No. 6,135,058, issued Oct. 24, 2000 to Jaeger, indicates a sanitary cat litter box and method of use. The sanitary cat litter box comprises a box top sized to frictionally fit onto a box bottom, an impervious bag sized to fit into the box bottom, and at least one sieve bag nested in the impervious bag. The box has a box mouth and a box aperture. The impervious bag has an impervious bag mouth co-extensive with the box mouth and an impervious bag aperture co-extensive with the box aperture. Each sieve bag has a sieve bag mouth co-extensive with the box mouth and a sieve bag aperture co-extensive with the box aperture. Means is provided to hold the corresponding box, impervious bag, and sieve bag mouths together, and to hold the corresponding box, impervious bag, and sieve bag apertures together. In use, the sieve bag(s) and impervious bag are placed within the box bottom, and the corresponding apertures attached. Cat litter is placed in the uppermost sieve bag, the corresponding mouths are attached, and the box top is installed on the box bottom. Each day, one sieve bag containing lumped cat litter and cat waste is removed from the sanitary cat litter box, and discarded. On the last day, only the impervious bag containing the remainder of the cat litter and any accumulated cat waste is removed and discarded, and a new sieve bag/impervious bag package is installed in the box bottom.

U.S. Pat. No. D426,684, issued Jun. 13, 2000 to Kenney, puts forth the ornamental design for a combined animal litter box and screen.

What is needed is a litter box system that includes a plurality of disposable mesh liner bags attached together near their top by a plurality of removable tabs, to allow the plurality of mesh liner bags to be lapped over the top edge of a litter box at the same time to allow each mesh liner bag to be removed individually, as needed with a mesh in each disposable mesh liner bag to allow the litter to sift through and lift out pet waste solids as each bag is individually removed from the litter box and a draw string cinches the bag closed for disposal and to eliminate the manual scooping of animal waste from the litter by pet owners.

### BRIEF SUMMARY OF THE INVENTION

It is the primary object of the present invention to provide a litter box system that eliminates the manual scooping of animal waste from the litter by pet owners. The litter box system has an upper half and lower half. The litter box system includes a plurality of disposable mesh liner bags attached together at the outer edges by a plurality of removable tabs, to allow the plurality of mesh liner bags to be simultaneously lapped over the top edge of the lower half of the litter box. After the plurality of mesh liner bags are in place and ready for use, the plurality of tabs are removed to allow each mesh liner bag to be removed individually, as needed.

The plurality of disposable mesh liner bags having a plurality of holes in their bottom to form a mesh are stacked inside each other and are removably attached to a rigid flat insert which is held in place, in the bottom half of the litter box, by a plurality of retainers. At least one retainer is fixed to one of the inside walls of the pet litter box. Other retainers are removable and slip over and clamp to the top edge of the lower half of the litter box and remain secured against an inside wall of the lower half of the litter box by a plurality of retainer bracket guides. As each disposable mesh liner bag is individually removed from the lower half of the litter box, it detaches from the rigid flat “insert” and is removed from the pet litter box leaving unused mesh liner bags still removably attached to the rigid flat “insert”. As each disposable mesh liner bag is being removed from the lower half of the litter box it collects and removes unwanted pet waste and simultaneously allows unsoiled litter to pass through and remain inside the lower half of the litter box. The use of mesh liner bag drawstrings help contain the animal waste during its collection and removal.

An advantage of the present invention is that it provides a quick, easy, convenient, inexpensive and a more sanitary way to manually remove pet waste from litter.

Another object of the present invention is to provide for a litter box system that includes a plurality of disposable mesh liner bags having a plurality of holes in their bottom.

Another object of the present invention is to provide for a litter box system that includes a plurality of disposable mesh liner bags that allow for the frequent collection of pet waste and simultaneously allows unsoiled litter to pass through and remain inside the lower half of the litter box.

Another object of the present invention is to provide for a litter box system that includes a plurality of disposable mesh liner bags stacked inside each other that can be individually detached from a rigid flat insert and removed from the lower half of the litter box without detaching any of the remaining mesh liner bags still removably attached to the rigid flat insert.

Another object of the present invention is to provide for a litter box system that includes a plurality of disposable mesh liner bags attached together with a plurality of removable tabs, to allow the plurality of mesh liner bags to be simultaneously lapped over the top edge of the lower half of the litter box.

Another object of the present invention is to provide for a litter box system that includes a plurality of retainers to secure a rigid flat “insert” inside the pet litter box at the bottom underneath the litter.

Another object of the present invention is to provide for a litter box system that includes a plurality of retainer bracket guides to secure removable retainers against the sidewall of the pet litter box.

Another object of the present invention is to provide for a litter box system that includes at least one L-shaped retainer fixed to one of the inside walls of the pet litter box.

Another object of the present invention is to provide for a litter box system that includes a rigid flat “insert” that allows a plurality of disposable mesh liner bags to be removably attached thereto.

Another object of the present invention is to provide for a litter box system that includes a rigid flat “insert” that allows mesh liner bags to be individually detached without detaching unused mesh liner bags.

Another object of the present invention is to provide for a litter box system that comprises a lid with no latches.

Another object of the present invention is to provide for a litter box system that comprises a lid with walls that extend down into the litter box to protect unused mesh liner bags from being damaged by pets during pet use of the litter box.

Another object of the present invention is to provide for a litter box system that comprises a lid with walls that extend down into the litter box to secure and stabilize the lid during pet use of the pet litter box.

Another object of the present invention is to provide for a litter box system that comprises a lid with walls that extend down into the litter box and conforms to the walls of the lower half of the pet litter box to allow the use of a plurality of mesh liner bags.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of a pet litter box system of the present invention that includes a plurality of disposable mesh liner bags removably attached to a rigid flat insert that lies flat at the bottom of the lower half of the pet litter box and a lid securing the mesh liner bags which are draped over the top edge of the retainer walls of the lower half of the box with an opening in the lid to admit a pet therethrough to use the litter box;

FIG. 2 is an exploded perspective view of the pet litter box of FIG. 1 with a stacked array of mesh liner bags shown aligned to be installed in the lower half of the pet litter box, showing a rigid flat insert at the bottom of the pet litter box held by a permanent and removable retainer brackets although the stacked array of mesh liner bags is actually removably attached to the flat insert prior to installation and the lid aligned for removable placement over the top edge of the retainer walls of the lower half with the array of mesh liner bags draped over the top edge;

FIG. 3 is a perspective view of a tab stapled to an array of mesh liner bags to hold them together until they are installed in the lower half of the litter box;

FIG. 4 is an edge elevational view of the retainers of FIG. 2 securing a rigid flat insert in place at the bottom of the pet litter box underneath the disposable mesh liner bags that are removably attached to the rigid flat insert and shown lapping over the lower half of the pet litter box, and the peripheral edges of the mesh liner bags are shown stretched out horizontally when they would actually be hanging down the outside of the pet litter box;

FIG. 7 is a perspective view of the pet litter box system of FIG. 1 that includes a plurality of disposable mesh liner bags lapping over the top edge of the pet litter box removably attached to a rigid flat insert that lies flat at the bottom of the pet litter box held in place with retainers, shown without the lid.

### DETAILED DESCRIPTION OF THE INVENTION

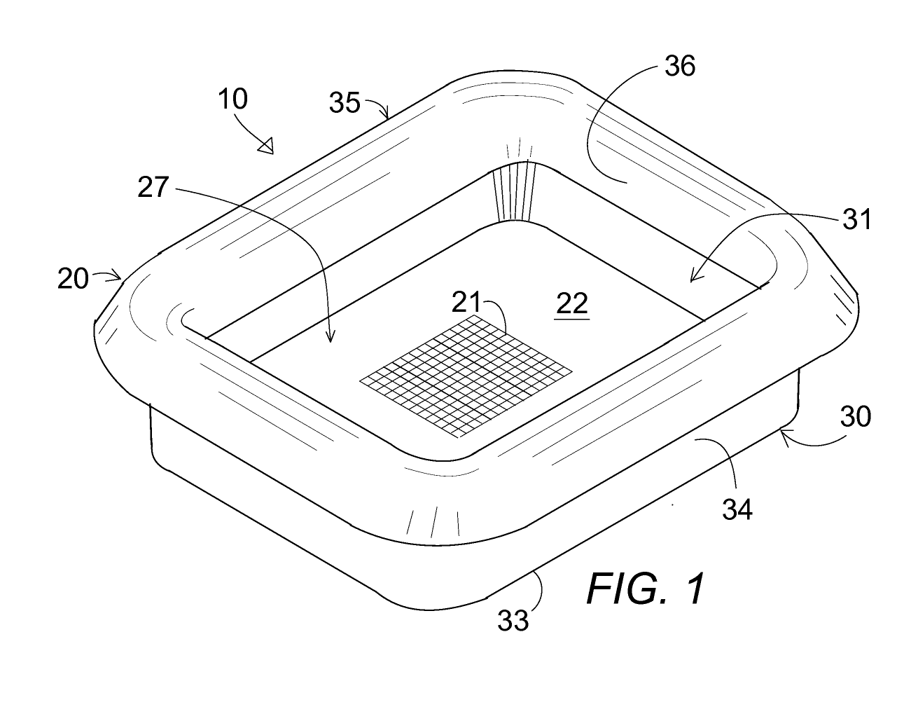

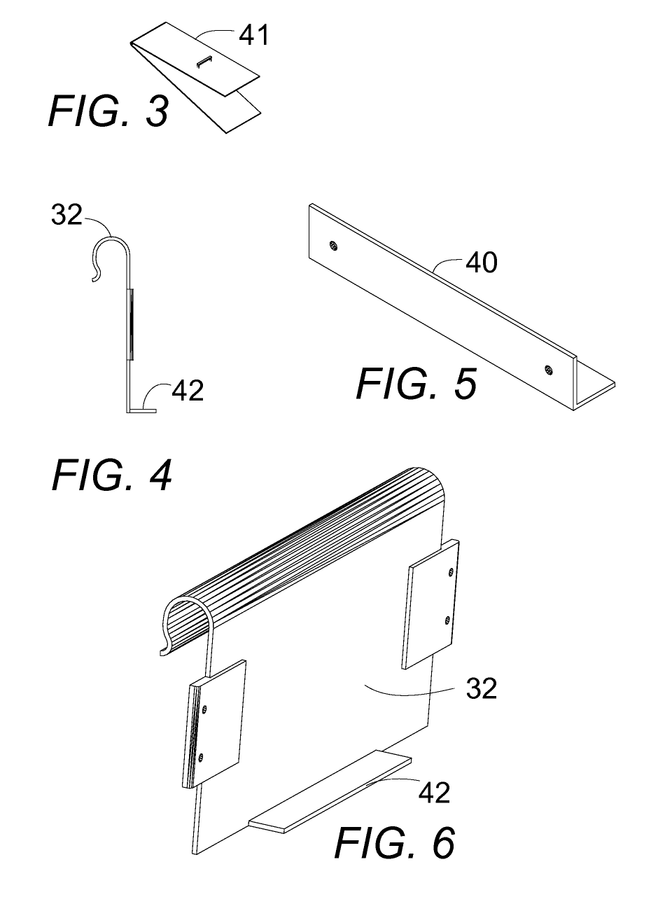

In FIGS. 1-7, a mesh liner pet litter box system 10 used to filter unsoiled litter and simultaneously allowing for the quick, easy, and convenient removal of pet waste. The litter box system 10 comprises a number of elements including a pet litter box upper half comprising a lid 35 and pet litter box lower half 30 with a stacked array 27 of disposable mesh liner bags 20, removably attached to a rigid flat insert 37 so that the mesh liner bags with a center mesh portion 21 can be easily detached from the rigid flat insert and removed one at a time simultaneously sifting through unsoiled litter on top of the stacked mesh liner bags and collecting solid pet waste from the pet litter box for disposal.

In FIGS. 1, 2, and 7, the lower half of the pet litter box 30 comprises a flat bottom 33, with a substantially vertical retaining wall 34 surrounding and extending upwardly from the flat bottom 33. The lower half of the pet litter box 30 holds a quantity of pet litter above the array 27 of mesh liner bags 20 for a pet to use for eliminating waste.

The mesh liner bags 20 are disposable bags each comprising a flexible sheet of disposable material having a flexible peripheral portion 23 and outer edge that overlaps and wraps over the top edge of the walls 34 of the lower half of the litter box 30. A center portion of each mesh liner bag has many small holes, preferably formed as a mesh surface 21.

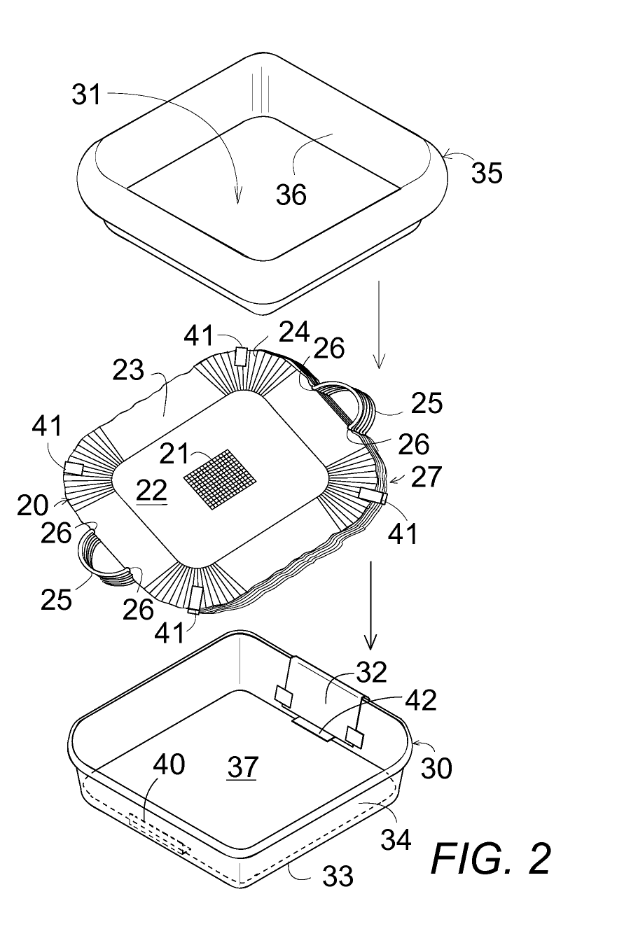

In FIG. 2, an array 27 of the mesh liner bags 20 are removably attached to a rigid flat insert 37 which lies flat inside the pet litter box at the bottom 33, held in place by a permanent L-shaped bracket 40 attached to a wall 34 and a clip 32 with a bottom L-shaped bracket removably hooked over an opposite wall. A flat portion 22 around the mesh 21 rests flat on the insert.

A drawstring or tie cord 25 is encased in an outer edge portion of each mesh liner bag 20 with holes 26 for the tie cord to protrude from opposing sides of the bag. The pet litter sits inside the mesh liner bags 20. The mesh liner bags 20 can be detached from the rigid flat insert and removed one at a time to allow for simultaneous sifting of unsoiled litter through the mesh 21 while collecting pet waste and by pulling the drawstring 25 tight to enclose the solid wastes and tie the two ends together for disposal. The unsoiled litter sifts through the mesh as the bag is lifted. The mesh liner bag opening is sufficiently wide so that the peripheral portions cover the retaining wall, and the edge portions overlap the top edge of the retaining walls 34 to form a lined pet litter box.

Multiple mesh liner bags are removably attached together to a rigid flat insert to form a bound stack of mesh liner bags that fit in the empty pet litter box prior to adding the pet litter to the box. Tabs 41 stapled around the edges of the array 27 of mesh liner bags 20 hold the array together for shipping and installing. The tabs are removed after installation in the pet litter box. This allows for removal of a single mesh liner bag 20 at a time without detaching and removing other mesh liner bags from the pet litter box.

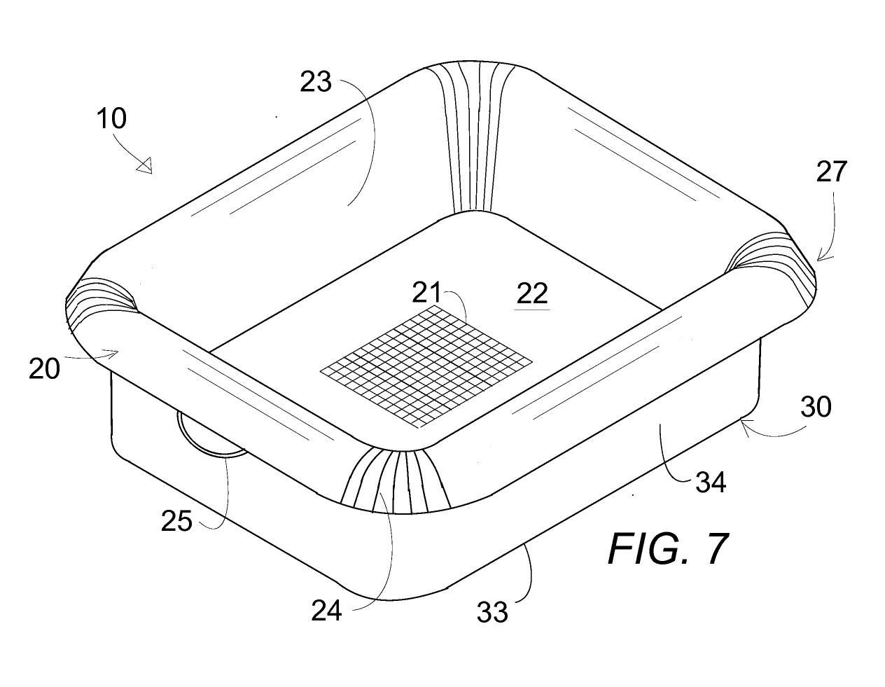

In FIGS. 1 and 2, the pet litter box further comprises an upper half forming a removable open lid 35 having a peripheral shell removably fitting over the top edge of the retaining wall 34 with the array 27 of mesh liner bags 20 installed in the lower half 30, as shown in FIG. 7 prior to the installation of the lid 35, so that the lid 35 retains the mesh liner bags in place until the lid 35 is lifted to remove one mesh liner bag at a time to clean the solid waste from the litter. A central opening 31 in the lid 35 to admit a pet therethrough for use of the lined pet litter box system. Inner lid walls 36 extend down into the box over the array 27 of mesh liner bags to protect the bags from damage by an animal using the pet litter box.

In use, the present invention makes litter box maintenance quick and easy, convenient and inexpensive and eliminates the scooping of animal waste by pet owners.

All disposable mesh liner bags are stacked inside each other and removably attached together to a rigid flat insert. The insert, with all mesh liner bags removably attached, are then placed in the bottom of litter box. A plurality of retainers 40 and 42 are installed to hold the insert inside the pet litter box at the bottom.

All mesh liner bags 20 in the array 27 are initially attached together at their edges with a plurality of tabs 41 and the array lapped over the top edge of the lower half of the litter box so that the innermost mesh liner bag is exposed first to allow for its individual removal without having to remove any of the remaining mesh liner bags. After the mesh liner bags are installed in the pet litter box, the tabs 41 are removed.

The upper half of the litter box comprising a continuous ridge lid 35, is then placed on top of the lower half of the litter box removably securing the array to the box. Litter is then placed inside the litter box to a recommended level. The litter box is then ready for animal use. Each time pet waste needs to be removed, the lid is lifted off and an individual mesh liner bag 20 removed and discarded while all unused mesh liner bags remain removably attached to the rigid flat insert inside the litter box. In use, the following steps are followed:

### Preparing Litter Box for Use:

1. Remove the litter box lid.
2. Place a package of disposable mesh liner bags inside the litter box. Make sure the insert is lying flat on the bottom of the litter box.
3. Install the removable retainer. Make sure the rigid flat insert remains under the bottom edge of both the permanently installed retainer and the removable retainer.
4. Simultaneously lap the outer edges of all the bags over the top edge of the of the litter box making sure the innermost bag is exposed first.
5. Remove tabs attaching the outer edges of the bags together
6. Install the litter box lid.
7. Pour clumping litter inside the litter box and maintain the litter level at the lower edge of the lid. The mesh liner litter box is ready for use.

### Removing Animal Waste:

1. Remove the litter box lid.
2. Gather the outer edges of the inner most bag and pull the drawstring tight until the top of the bag is closed and tie shut.
3. While holding the top of the bag pull left and then right to detach the bag from the rigid flat insert.
4. Lift and remove the bag from the litter box.
5. Place the used bag in a trash container.
6. Replace the litter box lid.
7. Add litter as needed to maintain the litter level at the lower edge of the lid.
8. When the last bag and litter is removed and disposed of, clean your pet litter box.

It is understood that the preceding description is given merely by way of illustration and not in limitation of the invention and that various modifications may be made thereto without departing from the spirit of the invention as claimed.

What is claimed is:

1. A lined pet litter box system comprising:
a pet litter box comprising a lower half with a flat bottom, a substantially vertical retaining wall surrounding and extending upwardly from the flat bottom, a top edge of the retaining wall forming a top opening to admit a pet into the pet litter box;
a plurality of disposable mesh liner bags each comprising a flexible sheet of disposable material having a center portion with a plurality of small holes forming a mesh for sifting litter therethrough, a flexible peripheral portion around the center portion, and a draw string encased in an outer edge portion to pull the drawstring tight to enclose the solid waste inside the mesh liner bag for disposal, the draw string opening sufficiently wide so that the plurality of disposable mesh liner bags lie with the center portions stacked in a flat horizontal array in a bottom of the pet litter box removably attached to a rigid flat insert secured to the bottom of the litter box, the peripheral portions cover the retaining wall, and the edge portions overlapping a top edge of the retaining wall to form a lined pet litter box with litter poured on top of the array; so that a single mesh liner bag at a time is detached and lifted to filter unsoiled litter through the mesh and collect pet waste solids in the mesh liner bag;
means for retaining the flat insert on the bottom of the litter box;
the pet litter box further comprising an upper half forming a removable open lid having a peripheral shell removably fitting over the top edge of the retaining wall with the array of mesh liner bags installed to retain the mesh liner bags in place and a central opening in the lid to admit a pet therethrough for use of the lined pet litter box system, the lid alternately removed to lift one mesh liner bag at a time to remove pet waste.

2. The system of claim 1 wherein the means for retaining the flat insert on the bottom of the litter box comprises a plurality of retainers to secure a rigid flat insert inside the lower half of the pet litter box at the bottom.

3. The system of claim 1 wherein the means for retaining the flat insert on the bottom of the litter box comprises retainer bracket guides.

4. The system of claim 1 wherein the means for retaining the flat insert on the bottom of the litter box comprises at least one L-shaped retainer fixed to one of the inside litter box walls and at least one removable bracket hooked over an opposite litter box wall, the removable bracket having a least one L-shaped retainer at a bottom end.

5. The system of claim 1 further comprising a plurality of removable tabs attaching the array of mesh liner bags together at the outer edges for simultaneous installation and overlapping over the retaining walls of the lower half of the pet litter box, with the plurality of tabs removed after installation.

6. The system of claim 1 wherein the lid has no latching mechanism.

7. The system of claim 1 wherein the lid further comprises substantially vertical walls extending down inside lower half of the pet litter box to avoid damage to the mesh liner bags by pets during use of the pet litter box.

8. The system of claim 1 wherein lid further comprises walls extending down inside the lower half of the pet litter box to secure and stabilize the lid during pet use of the pet litter box.

9. The system of claim 1 wherein a bottom mesh liner bag is solid with no mesh to lift the remaining litter out of the litter box for disposal.
